(19) United States
(12) Patent Application Publication
(10) Pub. No.: US 2012/0250022 A1
(43) Pub. Date: Oct. 4, 2012

(54) Hand-Held Color Measurement Device

(75) Inventors: Wang Long Zhou, Andover, MA (US); Andrew Masia, Newburyport, MA (US); Beat Frick, Buchs (CH)

(73) Assignee: X-Rite Europe GmbH, Regensdorf (CH)

(21) Appl. No.: 13/078,328

(22) Filed: Apr. 1, 2011

(51) Int. Cl. G01J 3/46

(52) U.S. Cl. 356/425

(57) ABSTRACT

A hand-held color measurement device is provided that includes a housing with an opto-measurement unit. The latter includes an optics array for receiving measurement light and a sensor array which is exposed to the measurement light, converts the measurement light into electrical measurement signals, and processes them to form digital measurement data. The measurement unit (M) consists of an aspherical input lens (L₁), an aperture (B) for limiting the incident angular range, a depolarizing diffuser (D), a sensor lens (L₂) and at least three sensors (S₁, 5₂, S₃) which are sensitized to different spectral ranges using color filters (F₁, F₂, F₃). The aperture (B) lies substantially in the focal plane of the input lens (L₁), and the diffuser (D) is arranged in the immediate vicinity of the aperture (B) and in the focal plane of the sensor lens (L₂). The filters (F₁, F₂, F₃) and the sensors (S₁, S₂, S₃) are arranged close to the optical axis (A) and exposed to substantially parallel measurement light. The filters (F₁, F₂, F₃) are configured to the spectral characteristics of the tristimulus color values XYZ according to CIE. For ambient light measurements, an additional diffuser (D_{E}) can be placed in front of the input lens.

### FIELD OF THE INVENTION

The invention relates to an opto-electronic measurement unit for a color measurement device, in particular a hand-held color measurement device for gauging monitors, projectors, projection areas and ambient light, and to a hand-held color measurement device.

### RELATED PRIOR ART

Hand-held color measurement devices of the generic type are available on the market in numerous embodiment variants. Such hand-held color measurement devices can be based on any measurement technologies. They can for example be embodied as filter measurement devices or as spectral measurement devices, wherein the latter are the most universal, since it is known that spectral measurement values can be used to derive any other variables which are of interest in practice (for example color values, color density values, etc.). Hand-held color measurement devices can also be embodied as autonomous devices or as peripheral measurement devices for use in connection with a controlling computer which processes measurement results. Autonomous hand-held color measurement devices include all the operating and display members necessary for measurement operations and also their own power supply and are in many cases also equipped with an interface for communicating with a computer, wherein both measurement data and control data can be exchanged with the computer. Hand-held color measurement devices which are configured as peripheral measurement devices do not generally have their own operating and display members and are controlled by the superordinated computer like any other peripheral computer device. For communicating with a computer, more modern hand-held color measurement devices are often for example fitted with a so-called USB (universal serial bus) interface, via which in many cases it is simultaneously also possible to supply power (from the attached computer). Such a design for measurement devices is described for example in U.S. Pat. No. 7,671,991 (≈EP 1 845 350 B1).

Hand-held color measurement devices of the generic type can be used for a large number of measurement tasks, depending on their embodiment and auxiliary equipment. One specific area of use for such hand-held color measurement devices is that of measuring on monitors, specifically for the purpose of calibrating and creating color profiles, wherein the hand-held color measurement device is manually positioned on the monitor to be measured and touches the monitor or is arranged at a small distance (preferably less than 20 cm) from the monitor. In other application functions, hand-held color measurement devices can also be used to measure the ambient light or possibly also for (remote) measurements on a projection area which is for example illuminated by an electronic projector (video projector). These points are likewise described for example in U.S. Pat. No. 7,671,991 (≈EP 1 845 350 B1).

For color measurement on monitors, particular demands are made on a color measurement device. The measurement device should thus for example exhibit a relatively large measurement spot in order to enable local inhomogenities in the monitor to be reduced by averaging. A relatively small acceptance angle (incident angular range) of typically ±4° which is the same for all colors is also desirable. As far as possible, the device must not exhibit any so-called pointing error, i.e. all the color channels of the device must see the same angular range. Global inhomogenities must not lead to color artifacts. A color artifact occurs if the sensitivities of the color channels R,G,B or, respectively, X,Y,Z of the monitor are not locally or angularly positioned perfectly on each other, such that mere brightness fluctuations in location or angle are incorrectly represented as color variations. Monitors with a significant angular dependence are particularly critical in this respect. The color measurement device must be insensitive to polarization of the measurement light. It should also exhibit a high degree of light sensitivity. It should simultaneously be as insensitive as possible to climatic and mechanical influences. Other requirements arise from the ever more prominent use of such devices in the semi-professional and private sectors: the color measurement device should be small, compact, easy to handle and stable over the long term, it must be able to be simply attached to an external computer, and it must lastly also be able to be manufactured in a cost-effective way.

### SUMMARY OF THE INVENTION

It is an intention of the present invention to provide an opto-electronic measurement unit designed for a hand-held color measurement device, and a hand-held color measurement device equipped with such an opto-electronic measurement unit, which fulfill the aforementioned requirements to the highest degree.

This preferred object can at least partially be solved by an opto-electronic measurement unit for a color measurement device, in particular a hand-held color measurement device for gauging monitors, projectors, projection areas and ambient light, comprising an optics array for receiving measurement light, emitted from a measurement object, and comprising a sensor array which is exposed to the measurement light, converts the measurement light into corresponding electrical measurement signals, and processes these measurement signals to form digital measurement data which characterizes the color of the measurement object, wherein the measurement unit which exhibits an optical axis consists of a convex input lens with a comparatively large diameter, an aperture for limiting the incident angular range to ±2 to 10°, an optical diffuser which has a depolarizing effect, a sensor lens and at least three photoelectric sensors which are sensitized to different spectral ranges using color filters, wherein the aperture lies substantially in the focal plane of the input lens, and the optical diffuser is arranged in the beam path in the immediate vicinity of the aperture and substantially in the focal plane of the sensor lens, wherein the filters and the sensors are arranged close to the optical axis and exposed to substantially parallel measurement light, and wherein the filters, the sensors and the diffuser are configured such that the electrical measurement signals generated by the sensors substantially represent the tristimulus color values XYZ according to CIE or a linear combination of these tristimulus color values XYZ.

Furthermore, the present invention can be represented by a hand-held color measurement device, comprising a housing in which an opto-electronic measurement unit is situated which receives measurement light, emitted from a measurement object, through a measurement window of the housing, converts it into corresponding electrical measurement signals, processes these measurement signals to form digital measurement data which, characterizes the color of the measurement object, and provides it via a communications interface, wherein the measurement unit which exhibits an optical axis consists of a convex input lens with a comparatively large diameter, an aperture for limiting the incident angular range to ±2 to 10°, an optical diffuser which has a depolarizing effect, a sensor lens and at least three photoelectric sensors which are sensitized to different spectral ranges using color filters, wherein the aperture lies substantially in the focal plane of the input lens, and the optical diffuser is arranged in the beam path in the immediate vicinity of the aperture and substantially in the focal plane of the sensor lens, wherein the filters and the sensors are arranged close to the optical axis and exposed to substantially parallel measurement light, and wherein the filters, the sensors and the diffuser are configured such that the electrical measurement signals generated by the sensors substantially represent the tristimulus color values XYZ according to CIE or a linear combination of these tristimulus color values XYZ.

Advantageous embodiments and developments of the opto-electronic measurement unit in accordance with the invention and the hand-held color measurement device in accordance with the invention are the subject of the dependent claims.

With respect to the opto-electronic measurement unit, the essence of the invention is as follows: an opto-electronic measurement unit for a color measurement device, in particular a hand-held color measurement device for gauging monitors, projectors, projection areas and ambient light, comprises an optical array for receiving measurement light, emitted from a measurement object, and a sensor array which is exposed to the measurement light, converts the measurement light into corresponding electrical measurement signals, and processes these measurement signals to form digital measurement data which characterizes the color of the measurement object. The measurement unit which exhibits an optical axis consists of a convex, preferably aspherical input lens with a comparatively large diameter, an aperture for limiting the incident angular range to ±2 to 10°, an optical diffuser which has a depolarizing effect, a sensor lens with a diameter which is typically smaller than the input lens, and at least three photoelectric sensors which are sensitized to different spectral ranges using color filters. The aperture lies substantially in the focal plane of the input lens, and the optical diffuser is arranged in the beam path in the immediate vicinity of the aperture and substantially in the focal plane of the sensor lens. The filters and the sensors are arranged close to the optical axis and exposed to substantially parallel measurement light. The spectral sensitivities of the color channels resulting from the filter spectra, the spectral sensitivities of the sensors used and the spectral transmission of all the other components of the optics, i.e. the lenses and the diffuser, are substantially configured to the spectral characteristics of the tristimulus color values XYZ according to CIE, such that the electrical measurement signals generated by the sensors substantially represent tristimulus color values XYZ according to CIE. Instead of the XYZ characteristics, the individual color channels and/or spectral sensitivities can also have a linear combination of the same.

The sensors are advantageously arranged at a distance from the sensor lens which substantially corresponds to the focal length of the sensor lens.

The aperture preferably limits the incident angular range to ±4 to 6°.

In accordance with one advantageous embodiment, the optical diffuser consists of a molecularly scattering material comprising a large number of scattering centers having a very small scattering angle, in particular polyoxymethylene. The optical diffuser is advantageously embodied as a thin plate with a plate thickness of 0.3 to 0.5 mm, in particular about 0.4 mm. The optical diffuser advantageously has a translucence of at least 25%, preferably at least 50%. It is also advantageous if the optical diffuser depolarizes at least 95%, preferably at least 99%, of the light which passes through it.

The input lens is embodied such that it projects parallel light onto a point. The sensor lens is embodied and arranged such that it projects light, which is divergently emitted from the diffuser, to infinity.

The color filters are advantageously embodied as transmission filters having a dielectric layered structure.

It is also advantageous if the color filters are positioned and fixed in an insert which respectively seals off the color filters and the sensors from each other and protects them against exposure to extraneous light and reciprocal scattered light.

With respect to the hand-held color measurement device, the essence of the invention is as follows: a hand-held color measurement device comprises a housing in which an opto-electronic measurement unit is situated which receives measurement light, emitted from a measurement object, through a measurement window of the housing, converts it into corresponding electrical measurement signals, processes these measurement signals to form digital measurement data which characterizes the color of the measurement object, and provides it via a communications interface, wherein the opto-electronic measurement unit is equipped with one or more features in accordance with the above descriptions, wherein for ambient light measurements, an external diffuser which is arranged such that it can be placed in front of the input lens of the measurement unit is advantageously provided on the housing.

### BRIEF DESCRIPTION OF THE DRAWINGS

In the following, the invention is discussed in more detail on the basis of an example embodiment which is shown in the drawings. There is shown:

FIG. 1 a sectional representation of the hand-held color measurement device in accordance with the invention, comprising an opto-electronic measurement unit in accordance with the invention;

FIG. 2 a schematic representation of the opto-electronic measurement unit of the hand-held color measurement device of FIG. 1;

FIG. 3 a cut-open oblique view of the opto-electronic measurement unit of the hand-held color measurement device of FIG. 1;

FIG. 4 an axial section through the opto-electronic measurement unit of the hand-held color measurement device of FIG. 1;

FIG. 5 a detail from FIG. 4 in an enlarged representation; and

FIG. 6 an exploded representation of some of the components of the opto-electronic measurement unit.

### DESCRIPTION OF EXEMPLARY EMBODIMENTS

The following convention applies to the description of the figures below: if individual reference signs are not indicated in a figure, then reference is made in this respect to the remaining figures and the corresponding portions of the description. “Measurement object” is understood to mean light sources of any type which are to be gauged using the hand-held color measurement device, in particular monitors, projection areas which are illuminated by projectors, and ambient light.

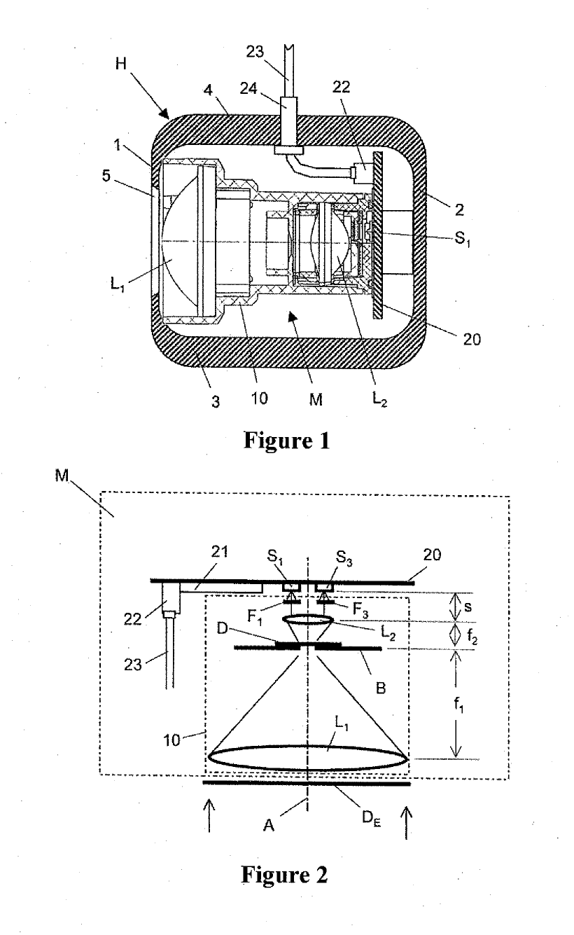

The exterior shape of the hand-held color measurement device in accordance with the invention can best be seen from FIG. 1. The device comprises a housing, which is indicated as a whole by H and comprises a substantially planar front wall 1, a rear wall 2 which is parallel to the front wall 1 and likewise substantially planar, a substantially planar lower wall 3, an upper wall 4 which is parallel to the lower wall 3 and likewise substantially planar, and two side walls (not shown) which are curved slightly outwards.

An opto-electronic measurement unit which is indicated as a whole by M is accommodated in the housing H and locally fixed by holding elements (not shown). The measurement unit M comprises a tube 10 which is staggered twice and comprises various optical components, and a printed circuit board 20 which is fastened to one end of the tube 10 and on which photoelectric sensors S₁ to S₄ are arranged (FIG. 2) which are exposed to measurement light via the optical components and convert it into corresponding electrical measurement signals. Measurement electronics 21 (FIG. 2) on the printed circuit board 20 which cooperate with the sensors control the sensors and provide their measurement signals in a digitized form at a communications interface 22. A cable 23 is attached to the communications interface 22, which is for example embodied as a USB interface, and guided through the upper wall 4 of the housing H to the outside in a protective and strain-relieving cable sleeve 24.

A measurement window 5 is provided in the front wall 1 of the housing H, wherein measurement light can enter the measurement unit M through said measurement window 5. The opto-electronic measurement unit receives light emitted from a measurement object, converts it into corresponding electrical measurement signals, processes these measurement signals to form digital measurement data which characterizes the color of the measurement object, and provides this measurement data to an external device, for example an external computer, via the communications interface and the cable attached to it. Power is also supplied to the measurement electronics via the cable.

In this general form, the hand-held color measurement device in accordance with the invention, including the measurement electronics, corresponds substantially to the known measurement devices of this type, as described for example in U.S. Pat. No. 7,671,991 mentioned at the beginning, and therefore need not be discussed in more detail in this respect. The difference with respect to the known prior art is the special embodiment of the opto-electronic measurement unit M, which is described in the following in all its essential details.

The measurement-technology concept of the opto-electronic measurement unit M in accordance with the invention is schematically shown in FIG. 2. An input lens L₁, an aperture B, a diffuser D, a sensor lens L₂, three color filters F₁ to F₃ and four photoelectric sensors S₁ to S₄ are arranged in the aforementioned tube 10, consecutively in the measurement beam path, wherein the four sensors are mounted on the printed circuit board 20 fastened to the end of the tube and are electrically connected to the measurement electronics 21 which are likewise situated on the printed circuit board.

The number of channels which are fitted with a filter can of course also be four or more (typically 3 to 12). Channels with no filter can equally be provided, which can then be fitted with special sensors, for example for measuring ultraviolet light or for quickly measuring measurement light which may be variable or pulsing over time.

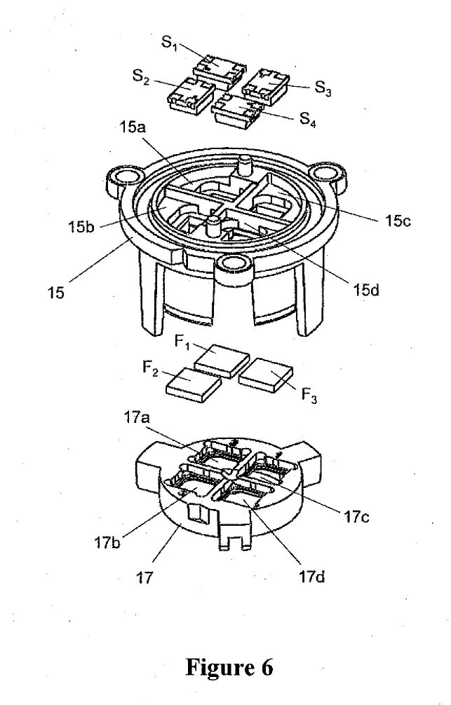

The three color filters F₁ to F₃ and the four sensors S₁ to S₄ are arranged close to the optical axis A of the measurement unit M. The three color filters F₁ to F₃ are each assigned to and/or connected upstream of one of the three sensors S₁ to S₃; the fourth sensor S₄ (FIG. 6) has no filter. The four sensors S₁ to S₄ are embodied in a way which is conventional in and of itself and are for example embodied as small circuits which are integrated on a chip in a CMOS technology. Suitable sensors include for example high-sensitivity light-to-frequency converter sensors of the type TSL238T by the, company TAOS.

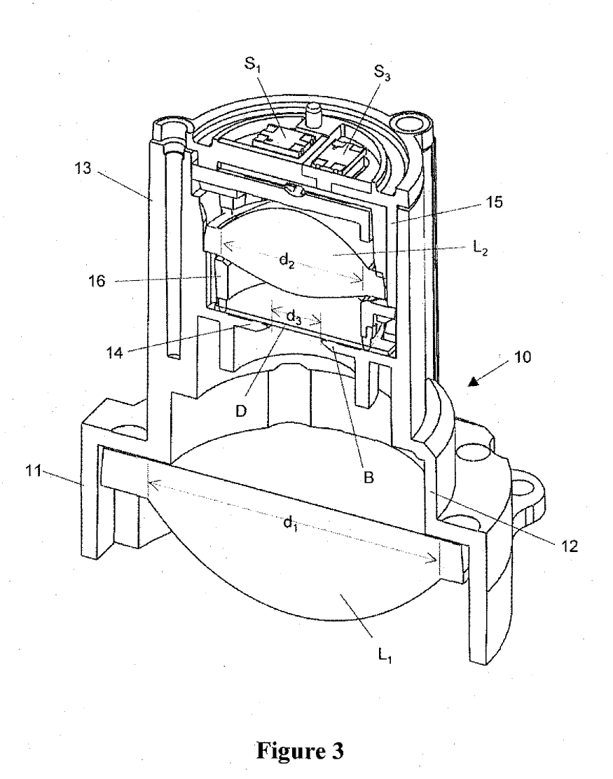

The input lens L₁, which is arranged immediately behind the measurement window 5, is embodied to be convex and, as required, aspherical and is optimized for projecting parallel measurement light, which enters it through the measurement window, onto a point. The input lens L₁ is relatively large and has a diameter d₁ of for example about 20 mm (FIG. 3). The focal length f₁ of the input lens L₁ is typically about 20 to 30 mm, in particular about 24 to 26 mm.

The aperture B is situated in the focal plane of the input lens L₁. The aperture diameter d₃ (FIG. 3) of the aperture B is typically about 3 to 5 mm, in particular about 4 mm. The aperture B limits the incident angular range (angle of view) of the measurement unit, wherein the focal length f₁ of the input lens L₁ and the aperture diameter d₃ of the aperture B are mutually adjusted such that an incident angular range of about ±2 to 10°, preferably about ±4 to 6°, results. This, in connection with the relatively large diameter of the input lens L₁, realizes a relatively large measurement spot of typically about 2.5 cm in diameter which is advantageous for measurements on monitors because local inhomogenities can thus be averaged out.

The diffuser D is arranged in the measurement beam path in the immediate vicinity of the aperture B. It consists of a thin plate made of a translucent, scattering and depolarizing material. The plate thickness of the diffuser D is about 0.3 to 0.5 mm, preferably about 0.4 mm. The diffuser D is preferably embodied such that it exhibits a translucence of at least 25%, preferably at least 50%, and almost completely depolarizes light passing through it (typically at least 95%, preferably 99% and more). The diffuser D is also embodied such that it generates a good mixture over all the incident angles and exhibits a low sensitivity to temperature and moisture. The diffuser D particularly preferably consists of a thin plate of a molecularly scattering material comprising a large number of scattering centers having a very small scattering angle, such as for example polyoxymethylene (POM), which is for example available from the company DuPont under the brand name DELRIN®. What is surprising is that a diffuser made of this material still exhibits a degree of depolarization of over 95% even at the very small plate thicknesses specified.

The first group of optical components, consisting of the input lens L₁, the aperture B and the diffuser D, acts as pick-up optics for the measurement light. The sensor lens L₂ and the color filters F₁ to F₃ form the sensor optics which follow the pick-up optics. The diffuser D acts as a secondary light source for the sensor optics, wherein the light is emitted diffusely and is (practically completely) depolarized. The light emitted has thus “forgotten” its original incident angle and its input polarization (if any). The light exits on the rear side of the diffuser D at (almost) the same point as it entered the diffuser on the front side. Accordingly, the light has not “forgotten” its incident point onto the diffuser D. This problem is solved by the telecentric embodiment of the sensor optics described below, which causes all the sensors to receive light from all the points of the diffuser D, i.e. causes each sensor to receive light from the entire diffuser, wherein all the points of the diffuser D are rated equally,

The sensor lens L₂ is arranged in the measurement beam path such that the diffuser D lies in the focal plane of the sensor lens L₂. The sensor lens L₂ typically has a smaller diameter d₂ than the input lens L₁ and has a focal length f₂ of about 3 to 8 mm, preferably about 6.5 mm. The sensor lens L₂ is optimized for projecting light, which is divergently emitted from the diffuser D which acts as a secondary light source, to infinity. The light thus passes the color filters F₁ to F₃ in a cone with an axis which is perpendicular to the surface of the color filters, wherein the apex angle of the cone is typically about ±10 to 20°. The sensor lens L₂ is also embodied and arranged such that the sensors S₁ to S₄ are exposed to light resulting from light of the diffuser D which is emitted in parallel, and/or the sensor lens L₂ is optimized for exposing the sensors S₁ to S₄ to light resulting from light of the diffuser D which is emitted in parallel.

The sensors S₁ to S₄ are arranged at a distance s from the sensor lens L₂ which substantially corresponds to the focal length f₂ of the sensor lens L₂.

The color filters F₁ to F₃ are embodied as transmission filters having a dielectric layered structure which very precisely determines the respective transmission curve. Such transmission filters also have the advantage that they can be manufactured to be very temperature-stable and moisture-stable. The transmission characteristics of such color filters are known to be highly dependent on the incident angle. The fact that the measurement light strikes the color filters practically perpendicular to the surface of the filter benefits the use of such filters and/or enables the use of such filters in the first place.

The spectral sensitivity of the color measurement device should correspond to the normal observer as defined in CIE 1931. The spectral sensitivity of the color measurement device follows substantially from the spectral transmission of the color filters and the spectral sensitivity of the sensors used. In addition, the transmission of the lenses, and the diffuser also play a role in this.

The spectral sensitivities of the three color channels fitted with the color filters F₁ to F₃ correspond to the tristimulus color values of the normal observer according to CIE 1931. The result of this is that the measurement signals generated by the sensors S₁ to S₃ directly correspond to the tristimulus color values XYZ according to CIE. Instead of the XYZ characteristics, the color channel sensitivities can of course also have a linear combination of the same.

A color filter is not connected upstream of the fourth sensor S₄, i.e. it receives unfiltered light. The measurement values of the fourth sensor can for example be evaluated for color-independent brightness measurements. The sensor is equally suitable for quickly capturing variable measurement light.

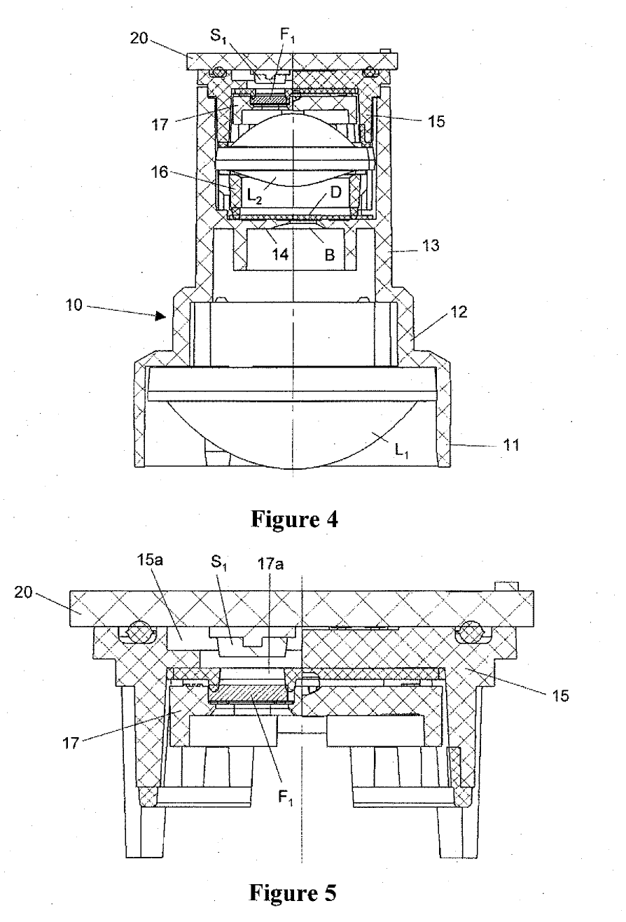

The physical structure of the measurement unit M can be seen from FIGS. 3 to 6. The central bearing element is the aforementioned tube 10 comprising three staggered portions 11, 12 and 13. The input lens L₁ is set in the front portion 11. A perforated wall 14 which forms the aperture B is provided in the rear portion 13, roughly in the middle of the tube 10. An insert 15 is arranged in the rear end of the rear tube portion 13. The printed circuit board 20 is fastened on the insert 15 and closes the tube 10. The terms “front” and “rear” refer to the measurement beam path, wherein “front” is understood to mean at the input end and “rear” is understood to mean at the sensor end. A supporting ring 16 in the rear tube portion 13 clamps the diffuser D against the rear side of the perforated wall 14 and forms a bearing surface for the sensor lens L₂ which is fixed on the opposite side by the insert 15.

The insert 15, which is shown on a larger scale in FIG. 5, serves on the one hand to hold the color filters F1 to F3 and on the other hand to optically isolate the color filters and the sensors from each other and also from extraneous light which could for example be reflected from the inner walls of the tube. The insert 15 is provided with two crossed, intermediate walls which divide in into four optically separate chambers 15a to 15d, as can best be seen from the exploded representation in FIG. 6. The sensors S₁ to S₄ are each situated within one of these chambers. A filter holder 17 is also fastened in the insert 15 and provided with four windows 17a to 17d which are optically isolated from each other. The three color filters F₁ to F₃ are each mounted in one of the three windows 17a to 17c; the fourth window 17d is empty.

The hand-held color measurement device in accordance with the invention is specifically suitable for measuring the luminosity and the tristimulus color values XYZ of the luminosity of a screen (monitor) or a projection area which is illuminated by a projector. These measurements can be taken for various modulations of the screen or projector, and the measurement data thus obtained can for example be adduced in order to create color profiles.

The hand-held color measurement device can also be used for ambient light measurements and for measuring the illumination intensity and the tristimulus color values of the illumination intensity on a work surface. In these applications, an external diffuser is placed in front of the input lens L₁, as schematically shown in FIG. 2. The external diffuser D_{E} can advantageously be provided on the housing H, where it is arranged such that it can be positioned in front of the measurement window 5 of the housing and then removed again from this position as required, for example by means of a suitable pivoting or sliding mechanism.

The hand-held color measurement device in accordance with the invention is an actual colorimeter (in accordance with the CIE normal observer) and fulfils the requirements listed at the beginning in a compact and easy-to-handle device comprising a USB port. Measurements on monitors taken using the hand-held color measurement device are independent of the underlying monitor technology. Since the primary colors of different types of monitor can be very different, the actual color matching function color filters used in the color measurement device in accordance with the invention are very advantageous. Measurements on a monitor taken using the color measurement device in accordance with the invention are independent of the measurement position and the monitor orientation and therefore extremely reproducible. Monitor measurements and calibrations based on them are independent of the degree of polarization of the light emitted from the monitor. This is another important advantage, since it is precisely LCD, OLED, AMOLED and other types of monitor which show highly significant linear or circular polarization.

1. An opto-electronic measurement unit for a color measurement device, comprising:
a. an optics array for receiving measurement light emitted from a measurement object, and
b. a sensor array which is exposed to the measurement light, converts the measurement light into corresponding electrical measurement signals, and processes these measurement signals to form digital measurement data which characterizes the color of the measurement object,
wherein the measurement unit which exhibits an optical axis includes a convex input lens with a comparatively large diameter, an aperture for limiting the incident angular range to ±2 to 10°, an optical diffuser which has a depolarizing effect, a sensor lens and at least three photoelectric sensors which are sensitized to different spectral ranges using color filters,
wherein the aperture lies substantially in the focal plane of the input lens, and the optical diffuser is arranged in the beam path in the immediate vicinity of the aperture and substantially in the focal plane of the sensor lens,
wherein the filters and the sensors are arranged close to the optical axis and exposed to substantially parallel measurement light, and
wherein the filters, the sensors and the diffuser are configured such that the electrical measurement signals generated by the sensors substantially represent the tristimulus color values XYZ according to CIE or a linear combination of these tristimulus color values XYZ.

2. The measurement unit according to claim 1, wherein the sensors are arranged at a distance from the sensor lens which substantially corresponds to the focal length of the sensor lens.

3. The measurement unit according to claim 1, wherein the aperture limits the incident angular range to ±4 to 6°.

4. The measurement unit according to claim 1, wherein in addition to the sensors, a sensor with no upstream color filter is provided.

5. The measurement unit according to claim 1, wherein the optical diffuser consists of a molecularly scattering material comprising a large number of scattering centers having a very small scattering angle, in particular polyoxymethylene.

6. The measurement unit according to claim 5, wherein the optical diffuser is embodied as a thin plate with a plate thickness of 0.3 to 0.5 mm.

7. The measurement unit according to claim 6, wherein the optical diffuser is at least 25% translucent.

8. The measurement unit according to claim 7, wherein the optical diffuser depolarizes at least 95% of the light which passes through it.

9. The measurement unit according to claim 1, wherein the input lens exhibits a focal length of 20 to 30 mm.

10. The measurement unit according to claim 1, wherein the input lens is optimized for projecting parallel light onto a point.

11. The measurement unit according to claim 1, wherein the sensor lens is optimized for projecting light, which is divergently emitted from the diffuser, to infinity.

12. The measurement unit according to claim l , wherein the aperture exhibits an aperture diameter of 3 to 5 mm.

13. The measurement unit according to claim 1, wherein the color filters are embodied as transmission filters having a dielectric layered structure.

14. The measurement unit according to claim 1, wherein the color filters are positioned and fixed in an insert which seals off the color filters and the sensors from each other and protects them against exposure to extraneous light.

15. The measurement unit according to claim 1, wherein the measurement unit takes the form of a hand-held color measurement device that is adapted for use in gauging at least one of the following: monitors, projectors, projection areas and ambient light.

16. A hand-held color measurement device, comprising:
a housing in which an opto-electronic measurement unit is situated which receives measurement light, emitted from a measurement object, through a measurement window of the housing, converts it into corresponding electrical measurement signals, processes these measurement signals to form digital measurement data which characterizes the color of the measurement object, and provides it via a communications interface,
wherein the measurement unit which exhibits an optical axis consists of a convex input lens with a comparatively large diameter, an aperture for limiting the incident angular range to ±2 to 10°, an optical diffuser which has a depolarizing effect, a sensor lens and at least three photoelectric sensors which are sensitized to different spectral ranges using color filters,
wherein the aperture lies substantially in the focal plane of the input lens, and the optical diffuser is arranged in the beam path in the immediate vicinity of the aperture and substantially in the focal plane of the sensor lens,
wherein the filters and the sensors are arranged close to the optical axis and exposed to substantially parallel measurement light, and
wherein the filters, the sensors the diffuser are configured such that the electrical measurement signals generated by the sensors substantially represent the tristimulus color values XYZ according to CIE or a linear combination of these tristimulus color values XYZ.

17. The hand-held color measurement device according to claim 16, wherein the sensors are arranged at a distance from the sensor lens which substantially corresponds to the focal length of the sensor lens.

18. The hand-held color measurement device according to claim 16, wherein the aperture limits the incident angular range to ±4 to 6°.

19. The hand-held color measurement device according to claim 16, further comprising, in addition to the sensors (S₁, S₂, S₃), a sensor (S₄) with no upstream color filter.

20. The hand-held color measurement device according to claim 16, wherein the optical diffuser consists of a molecularly scattering material comprising a large number of scattering centers having a very small scattering angle.

21. The hand-held color measurement device according to claim 20, wherein the optical diffuser is embodied as a thin plate with a plate thickness of 0.3 to 0.5 mm.

22. The hand-held color measurement device according to claim 21, wherein the optical diffuser is at least 25% translucent.

23. The hand-held color measurement device according to claim 22, wherein the optical diffuser depolarizes at least 95% of the light which passes through it.

24. The hand-held color measurement device according to claim 16, wherein the input lens exhibits a focal length of 20 to 30 mm.

25. The hand-held color measurement device according to claim 16, wherein the input lens is optimized for projecting parallel light onto a point.

26. The hand-held color measurement device according to claim 16, wherein the sensor lens (L₂) is optimized for projecting light, which is divergently emitted from the diffuser, to infinity.

27. The hand-held color measurement device according to claim 16, wherein the aperture exhibits an aperture diameter of 3 to 5 mm.

28. The hand-held color measurement device according to claim 16, wherein the color filters are embodied as transmission filters having a dielectric layered structure.

29. The hand-held color measurement device according to claim 16, wherein the color filters are positioned and fixed in an insert which seals off the color filters and the sensors from each other and protects them against exposure to extraneous light.

30. The hand-held color measurement device according to claim 16, wherein another diffuser which is arranged such that it can be placed in front of the input lens is provided on the housing.
